(19) United States
(12) Patent Application Publication
(10) Pub. No.: US 2005/0009000 A1
(43) Pub. Date: Jan. 13, 2005

(54) Method for the devitalisation of natural organs and/or for the preparation of extracellular matrices for tissue engineering

(76) Inventors: Peter Lamm Wilhelm, Fuerstenfeld Bruck (DE); Gerd Michael Juchem, Munich (DE)

Correspondence Address: Peter Lamm, Rebhuhnweg 20, FuerstenfeldBruck, 82256, DE

(21) Appl. No.: 10/485,947

(22) PCT Filed: Aug. 6, 2002
(86) PCT No.: PCT/EP02/08781

(30) Foreign Application Priority Data
Aug. 6, 2001 (DE) 101 38 564.1

(51) Int. Cl. A01N 1/02

(52) U.S. Cl. 435/1.1

(57) ABSTRACT

74. Culture medium according to any one of claims 48 to 73, characterized in that, that autologous growth factors are gained through chemical and/or biochemical destruction of body-own tissues.

75. Culture medium according to any one of claims 48 to 74, characterized in that, that autologous growth factors are gained through apoptosis of body-own tissues.

76. Culture medium according to claim 74, characterized by the fact that tissue destruction is done by ultrasound. Summary The invention provides new procedures for the devitalization and preserving of human and animal organs and tissues, preferably however natural hollow organs and all of their components, in particular from blood vessels and cardiac valves. Furthermore the invention provides procedures for the production of matrices for construction of organs and tissues in part or in toto. In addition the invention concerns organs and tissues, in particular natural and artificial hollow organs which can be achieved according to invention-appropriate procedures. Furthermore the invention concerns the clinical use of these organs and tissues an the application in the human and veterinarian medicine, preferably in the cardiac and vascular surgery. Furthermore the invention concerns new culture media.

The invention provides new procedures and processes for the devitalization and preservation of human and animal organs and tissues, preferably however natural hollow organs and all of their components, in particular from blood vessels and cardiac valves. Furthermore the invention provides procedures and processes for the production of matrices for the construction of organs and tissues in part or in toto. In addition the invention concerns organs and tissues, in particular natural and artificial hollow organs which can be achieved according to invention-appropriate procedures and processes. Furthermore the invention concerns the clinical use of these organs and tissues and the application in the human and veterinarian medicine, preferably in cardiac and vascular surgery. The invention-appropriate procedures and processes generate organs and tissues which show a higher mechanical stability and a better suitability for the further procurement by tissue engineering as compared to organs and tissues produced with traditional procedures. In particular the immunological compatibility and antithrombogenicity of the processed organs and tissues are a significantly improved by the invention-appropriate wash out technique of unwanted cell decomposition products and cell debris. Such organs and tissues show significantly reduced thrombogenicity and immunogenicity in comparison with the raw materials (organs and tissues) used. The same applies to organs and tissues which are only prepared in part according to the invention-appropriate procedures, i.e. without the invention-appropriate wash out step.

Up to now various preservation techniques are used for the preservation and storage of organs and body tissues, designed for reusage in human:

The short-term storage of human cardiac valves for 3 to 4 days in an antibiotic cocktail at 4° C. is carried out, when there is already a recipient for the specific heart valve at the time of harvesting the donor valve. This technique is known as fresh wet transplantation. A longer storage of organs using this technique results in destruction of the specific organ.

Furthermore the storage of organs and tissues using so called cross-linking agents, such as glutaraldehyde, formaldehyde, polyether oxide (polyepoxy compound), hexamethylene or acylazide is known. An advantage of this technique is the possibility for the long-term storage after preparatory treatment with this technique. A disadvantage is however the basic non-suitability of such preprocessed tissues for use in body systems which are exposed to a high mechanical stress, as for example the arterial blood system. Veins and arteries preprocessed in such a way demonstrate at present a high early graft occlusion rate and a high mechanical failure rate. Experiments trying to detoxify cross-linking agents and recontruct them by methods of tissue engineering have been up to now unsuccessful.

The clinically most important preservation technique of organs and tissues is the cryopreservation.

The cryopreservation and storage of organs and body tissues for preservation and later use, i.e. within the framework of a transplantation, are known and clinically established. The employed techniques distinguish in this case only slightly (Brockbank K G M. Basic Principles of Viable Tissue Preservation. In: Transplantation Techniques and Use of Cryopreserved Allograft Cardiac Valves and Vascular Tissue. D R Clarke (ed.), Adams Publishing Group Ltd., Boston. S 9-23. American Association of Tissue Banks Standards for Tissue Banking (1995), A.A.T.B., McLean, Va., U.S.A. European Association of Tissue Banks General Standards for Tissue Banking (1995), E.A.T.B., Vienna, Austria).

The cryopreservation is used primarily for the storage of human cardiac valves, the so-called homografts, and for the storage of human veins or other tissues.

The use of cryopreserved vein allografts for example is an established procedure in bypass surgery (Brockbank K G M et al., Cryopreserved vein transplantation. J. Cardiac Surg. 7:170-176, 1992; Gelbfish J. et al., Cryopreserved homologous saphenous vein: Early and late patency in coronary artery bypass surgical procedures. Ann. Thorac. Surg. 42:70, 1986; Fujitani R M et al., Cryoperserved saphenous vein allogenic homografts: An alternative conduit in lower extremity arterial reconstruction in infected fields. J. Vasc. Surg. 15: 519-526, 1992) and is used in patients, lacking enough body-own vessel material or with vessels of insufficient quality. Such cryopreserved veins are also frequently used as bypass grafts in infected body areas. Here the use of prosthetic material prohibits itself through the high, material-related incidence of prosthesis infection.

However, cryopreserved veins show a bad long-term patency rate (Bilfinger T V et al., Cryopreserved Veins in Myocardial Revascularization: Possible Mechanism for Their Increased Failure. Ann. Thorac. Surg. 63: 1063-69, 1997 and comment in Ann. Thorac. Surg. 64: 1524-5, 1997. Marshin R S et al., Cryopreserved Saphenous Vein Allografts for Below Knee Lower Extremity Revascularization. Ann. Surg. 219: 664-72, 1994). The reason for it is most likely an immunological degeneration of the vein walls (Carpenter J P, Tomaszewski J E, Immunosuppression for Human Saphenous Vein Allograft Bypass Surgery: a Prospective Randomized Trial. J. Vasc. Surg. 26: 32-42, 1997. Carpenter J P, Tomaszewski J E, Human Saphenous Vein Allograft Bypass Grafts: Immune response. J. Vasc. Surg. 27:492-9, 1998). In addition thrombotic early graft occlusions of cryopreserved veins is frequently observed. These two problems have been traced back to damage of the donor endothelium which took place during the cryopreservation process. This can result in the total absence of the endothelium or a limited functioning of the same (Brockbank K G M et al., Cryopreserved vein transplantation. J. Cardiac Surg. 7:170-176, 1992; Brockbank K G M et al., Functional analysis of cyropreserved veins. J. Vasc. Surg. 11:94-102, 1990. Laub G W et al., Cryopreserved allograft veins as alternative coronary conduits: early phase results. Ann. Thorac. Surg. 54:826-31,1992. Louagie Y A et al., Viability of long term cryopreserved human saphenous veins. J. Cardiovasc. Surg. 31: 92-100, 1990).

As a result of this, cryopreservation techniques for allografts and xenografts have been published and already patented that aim to guarantee a high degree of preservation of the donor endothelium. This degree of preservation of the donor endothelium of cryopreserved tissue is given in the literature as being 50-80% (Bambang L S et al., Effects of cryopreservation on the proliferation and anticoagulant activity of human saphenous vein endothelial cells. J. Thorac Cardiovasc. Surg. 110:998-1004).

However a major role has recently been assigned to the endothelium as being the culprit for acute and chronic organ rejection. Endothelium specific, non HLA antigens which lead to the activation of CD4 T-cells enables the donor endothelium to supply the recipients immune system with foreign antigens in conjunction with other accessory molecules. The release of non HLA antigen by damaged endothelial cells leads to a chronic immune reaction and possibly to graft vasculopathy and chronic rejection (Rose M L, Role of endothelial cells in allograft rejection. Vasc. Med. 2(2): 105-14, 1997; Reul R M, Fang J C, Denton M D et al, CD 40 and CD 40 ligand (CD 154) are coexpressed in microvessels in vivo in human cardiac allograft rejection. Transplantation 64(12): 1765-74, 1997; Salom R N, Maguire J A, Hancock W W, Endothelial activation and cytokine expression in human acute cardiac allograft rejection. Pathology 30(1): 24-29, 1998). On the other side the selective removal of the donor endothelium results in the absence of acute rejection reactions in the animal experiment (rat) (Ann. Surg. 206: 757-764, 1987), resulting later in spontaneous reendothelialization. In such a way preprocessed bypasses showed in the animal experiment improved patency rates.

Paying heed to these considerations that immunologically caused rejection reactions origin from all cellulare components of the transplantats, divers methods were developed for removal of these cells (U.S. Pat. No. 5,613,982). In among others various hydraulytic enzymes (i.e. proteases, lipases, nucleotidases, glycosidases etc.) were used as well as physical-chemical methods (use of hypotonic media or detergents, steam stage freezing processes, pH extremes etc.) (U.S. Pat. No. 5,192,312; U.S. Pat. No. 5,632,778; U.S. Pat. No. 5,613,982, U.S. Pat. No. 5,843,182, WO 95/24873). The main disadvantage of all these methods is the fact that this treatment may harmfully alter the stability of other important components for the structural integrity of hollow organs, such as collagens, in particular type I collagen, proteoglycane or glycoproteine. This is all the more important, since most difficult complications which are caused by structural wall weakness of the cryopraeserved veins, such as vein wall tears or aneurysms of the vein wall may lead to complication-prone re-operations, even a long time after implantation in humans (Lehalle B et al., Early rupture and degeneration of cryopreserved arterial allografts. J. Vasc. Surg. 25: 751-2, 1997. Couvelard A. et al., Human allograft failure. Hum. Pathol. 26: 1313-20, 1995). If decellularized tissue serves for recellularization procedures as a matrix it becomes necessary, to incubate the tissue supposed to be transplanted with high concentrations of specific adhesion factors and/or growth factors to facialiate a repopulation of cells in the vessel wall (U.S. Pat. No. 5,632,778 and 5,613,982 and/or U.S. Pat. No. 5,192,312, U.S. Pat. No. 5,843,182, WO 95/24873). Apart from the fact that it is unknown which influence the high non-physiological concentrations of these substances may have on the functional differentiation of tissue their usage is raising clinical and legal objections. This is extremely important, since only fully differentiated endothelium is effective (Ku D et al., Human coronary vascular smooth muscle and endothelium-dependent responses after storage at −75° C. Cryobiology 29:199-209, 1992).

It is known at present, that there remains a certain percentage of viable donor cells after traditional cryopreservation, which has been discussed being the culprit for immunological reactions (Yankah A C et al., Antigenicity and fate of cellular components of heart valve allografts. In: Yankah A C, Hetzer R, Yacoub M H, eds. Cardiac valve allografts 1962-1987. Current concepts on the use of aortic and pulmonary allografts for heart valve substitutes. Darmstadt: Steinkopff Verlag 1988). On the other hand other authors consider the viability of the transplants for immunologically unimportant and claim a better endurance of viable transplants (O'Brian M F et al., A comparison of aortic valve replacement with viable cryopreserved and valves, with note on chromosomal studies. J. Thorac. Cardiovasc. Surg. 94:812-23, 1987. Angell W W et al., Long term function of viable frozen aortic homografts: a viable homograft valve bank. J. Thorac. Cardiovasc. Surg. 93: 815-22, 1987). In general however the viable homograft is preferred today. There is a mild rejection reaction in human when ABO compatible cryopreserved homografts are used for aortic valve replacement. If ABO incompatible homografts are used there is a moderate acute rejection reaction. In both cases of rejection reactions a T-cell activation was detectable for 4-10 days. A clinical relevancy did not exist (Fishing flax T et al., Immunologic reaction and viability of cryopreserved homografts. Ann. Thorac. Surg. 60: 12-6, 1995).

Except for these disadvantages the findings for the distribution of antithrombogenic and/or prothrombogenic activities in the wall of hollow organs are up to now hardly considered in the appropriate literature. Since vascular endothelium (covering tissue of the internal- and/or luminal side of all blood vessels and blood vessel valves) is characterized by antiaggregatory, anticoagulatory and profibrinolytic activities (Z. Kardiol. 82: Suppl. 5, 13-21, in 1993; FASEB J. 2: 116-123, in 1988), the cellular components of the deeper vessel wall are characterized by the expression of tissue factor, which in contact with plasma factors initiate immediately the clotting cascade (Thrombosis Res. 81: 1-41, 1996; J. Clin. Invest. 100:2276-2285, 1997; FASEB J. 8: 385-390, 1994; Arterioscler. Thromb. Vasc. Biol. 17: 1-9, 1997). The protection from the prothrombotic activities of the wall of hollow organs is of utmost physiological importance not only in blood vessels and blood vessel valves but also in all others cryopreserved and non cryopreserved natural or artificial hollow organs or vessels.

It it is for example known that the thrombomodulin activity of the remaining donor endothelium is reduced after cryopreservation. This leads to a reduction of the anticoagulatory function of the donor endothelium (Bilfinger T V et al., Cryopreserved veins in myocardial revascularization: possible mechanism for their increased failure. Ann. Thorac. Surg. 63: 1063-9, 1997).

To avoid the disadvantages mentioned above it was early proposed to develop new or modified organs with improved antithrombotic properties by means of tissue engineering (Weinberg C B, Bell E. A blood vessel model constructed from collagen and cultured vascular cells. Science. 1986;231:397-400.). In doing so, experiences could be used which have been gained from endothelial cell seeding on the luminal surfaces of prosthetic surfaces (Zilla P, R Fasol, Deutsch M, Fischlein T, Minar E, A Hammerle, Krupicka O, Kadletz M. Endothelial cell seeding of polytetrafluoroethylene vascular grafts in humans: a preliminary report. J Vasc Surg. 1987;6:535-41.) Zilla et al. were able to prove that a stable endothelial cell layer in fact improves the antithrombogenic properties of these prostheses. A endothelial cell lining of blood vessels for implantation purposes is today a declared aim of biotechnology and tissue engineering.

In vitro studies that we carried out regarding the endothelialization of cryopreserved allograft veins showed that a precoating of the veins with autologous serum presented an ideal matrix for the cell repopulation of the inner surface of the veins. A precoating with patients autologous serum in physiological concentrations promoted not only the adhesion but also the functional differentiation of the endothelial layer (Lamm P et al. New autologous coronary bypass graft: First clinical experience with an autologous endothelialized cryopreserved allograft. J Thorac Cardiovasc Surg 117: 1217-9, 1999). This precoating is superior to a precoating with with fibronectin with and without a proteoglycan (for example heparinsulfate) (U.S. Pat. No. 5,192,312; U.S. Pat. No. 5,632,778; U.S. Pat. No. 5,613,982, U.S. Pat. No. 5,843,182, WO 95/24873, Zilla P. et al., Endothelial cell seeding of polytetrafluoroethylene grafts in humans. J. Vasc. Surg. 6: 535-541, 1987) because of the shortening of the cell lining procedure and the total nonuse of clinically not authorized substances (for example fibronectin). Since the serum is totally autologous there are no clinical or legal objection.

This invention provides therefore a new, generally applicable method for the preservation and storage of organs and tissues, in particular however of hollow organs. A further task of the invention was to provide organs and tissues that show a higher mechanical stability and a better suitability for the further procurement by the methods of the tissue engineering than the traditional procedures and tissues. In particular there is a significant improvement in the immunological compatibility and antithrombogenicity of organs and tissues which are treated by the invention-appropriate wash out techniques of unwanted cell decomposition products and cell debris. Such organs and tissues show in comparison with the initially untreated organs and tissues a significantly reduced immunogenicity and thrombogenicity. The same applies for organs and tissues which have not been treated by the invention-appropriate wash out technique.

This task is solved by the patent claims, the following description and the illustrations.

The present invention describes a procedure or process for the devitalization and preservation of organs and/or tissues relating to sterile harvesting of organs and tissues until achieving a devital steady state in a liquid selected from the group consisting of: sterile water, a crystalloid liquid, a colloidal liquid, a lipid-containing liquid and a combination of the before mentioned liquids. In the next step cell fragments, cellular decomposition products as well as other soluble substances are washed out under pressure (depending on the organ or tissue to be perfused) preferably however using the physiologic natural organ or tissue specific perfusion pressure, using a liquid or a group of liquids from the list of liquids mentioned above. The wash out process is preferably performed pulsatile, i.e. using variable increase and decrease pressure curves, depending on the preservation time. The process consists of organ and tissue specific pressure wave forms. Optimization of organ and tissue specific pressure wave forms is dependant on the increase or decrease pressure curves which are necessary to achieve a devitalization in the respective organ or tissue. The pressure increase velocity, the pressure niveau and the pressure decrease are adapted to each specific organ or tissue and are optimal, if the wash out of cell debris leads to simultaneous preservation of the extracellular matrix. The preservation of the extracellular matrix and the successfull wash out of cell debris (cell particles, cell remnants) may be histologically controlled. The condition of these process is choosen in such a way that it does not prevent at all the formation of a so called collagen-cross-linking. This may be controlled again by histological examinations.

Furthermore the present invention provides a process for generating matrices for the partial or denovo synthesis of organs and/or tissues. This procedure comprises the steps of the devitalization and preservation of organs and/or tissues according to the invention-appropriate and of the cell repopularization of organs and tissues, for example by means of reendothelialization. Additionally the invention provides a cultivation apparatus to be used for the invention-appropriate procedure.

The invention-appropriate procedure is suitable for the production of modified body-own organs and tissues for immediate clinical use of these organs and tissues. Arteries and veins for example may be implanted immediately after the invention-appropriate production process without any additional procurement (for example cryopreservation). The invention-appropriate produced organs and tissues demonstrate a significantly higher biomechanical stability than the same organs and tissues after traditional storage and preservation techniques (for example cryopreservation). In Addition the invention provides processes which are suitable to procure invention-appropriate organs and tissues by the methods of tissue engineering in a clinically safe manner. In particular this disclosure provides a process for cell lining of hollow organs with vascular endothelium. These hollow organs are achieved by the invention-appropriate procedure. In addition the invention-appropriate procedure may be used to treat organic and/or artificial surfaces, which have been precoated with components of the extracellular matrix (for example collagene, glycosaminoglycane etc.), such as the inner surface of artificial hearts or PTFE- and dacron-protheses, to render a reduced thrombogenicity and immunogenicity when compared to the non-preatreated surfaces.

Definitions

“Organ” is defined as a part of the body, which consists of cells and tissues that form a unit with specific tissues. ” The term “Tissue” means, individual kinds of cell groups that have common functions and that build up the body.

“Invention-Appropriate Organs” are organs of the above definition, that passed the invention-appropriate manufacturing-process and which may only perform their functions completely or in part after an additional procurement by cellrepopulation of the organs, in particular by reendothelialization. The cellrepopulation occurs preferably through methods of tissue engineering.

“Invention-Appropriate Tissues” are tissues of the above definition, that passed the invention-appropriate manufacturing-process and which may be used clinically with or without a further procurement by cellrepopulation of organs, preferably reendothelialization, in particular by the methods of tissue engineering.

Tissues, according to the definition are also hollow organs. Hollow organs are for example blood vessels, blood vessel valves, lymphatic vessels, lymphatic vessel valves, cardiac valves, ureters, spermatic ducts and bronchial tubes.

“Invention-Appropriate organic- or artificial surfaces” are surfaces that were precoated with extracellular matrix or matrix components and processed with the invention-appropriate procedure.

The term “crystalloid liquid” means every form of buffered or unbuffered saline solutions. Favoured saline solutions within the framework of the invention are phosphate buffered saline or clinically authorized electrolyte solutions (ringer solution).

The term “colloidal liquid” means protein and/or sugar-containing solutions. Most preferred solutions are Medium 199 and Brettschneider cardioplegic solution.

The term “lipid-containing liquid” means every form of fat containing solutions.

The term “dark” means without influence of a natural or artificial source of light.

The term “under pressure” means perfusion of tissues and organs with invention-appropriate liquids under application of pressure, depending on the specific tissue or organ, preferably however under application of organ and tissue specific pressure values (i.e. the generally known typical blood pressure values (=the physiological pressure) for the specific tissue and organ). In the case of invention-appropriate hollow vessels, a transmural pressure gradient of about 20 to 100 mmHg is preferred. In the case of complex organs, as for example the liver, the pressure gradient is applicated via the natural blood influx and the organ environment.

“Steril” means not exposed to germs.

The term “variable flow” means that it is possible to generate different flow rates in hollow organs by use of the patented cultivation apparatus. This may be used to increase the expression of adhesion molecules from endothelial cells in the early phase of the invention-appropriate cell lining of hollow organs with endothelial cells by increasing flow rate and transmural pressure.

The term “Lyophilization” describes a known procedure that is used for the preservation of labile, altering biological substances. The substances to be dried become frozen mildly in a cooling mixture (for example carbonic acid snow in methylated alcohol) and are brought subsequently under high vacuum (upper boundary of the gap: 0.05-0.1 Torr). The ice sublimates and the water steam becomes rapidly removed by a pump supported by suitable hygroscopic means (for example deep-freezing-condenser) that in result of the vaporization cold the substance to be dried remains in the frozen state.

The term “Critical-Point-Drying” describes a known procedure for the drying of biological samples. Whereby water gets exchanged by a intermediate medium (for example ethanol). This intermediate medium gets exchanged by carbondioxide. By doing this one takes advantage of the fact that it is impossible above the so called critical point to distinguish between fluid and gaseous stage. It is therfore possible to bypass the direct phase transition fluid-gaseous.

“Antibiotic” means fungal or bacterial metabolism products and their modification products with hampering or killing effect against viruses, bacteria and fungals. Gentamicin is one of the preferred invention-appropriate antibiotics.

The term “Devitalization” means killing of all cells and the reduction of the corresponding organs and tissues to the level of the connective tissue. This condition is also called “Achieving of Devitalization”. Devitalization can be controlled histologically.

The term “devital steady state” means the state of organs and tissues after devitalization. Devitalization is further characterized by the fact that important modulation of the extracellular matrix of organs and tissues, for example the intramolecular cross linking of collagens, is already advanced and irreversible.

The term “Tissue engineering” describes techniques which allow divers, sometimes organ specific cells to isolate, to cultivate and to propagate (for example reendothelialization of hollow organs such as arteries or veins). Finally new organs and tissues arise from these techniques.

The term “matrix” means scaffold for the reconstruction or the modification of organs and tissues by the methods of tissue engineering. Cells in the tissue culture are propagated onto this “Matrices”.

The term “Repopularisation” means the repopulation with organ or tissue-specific cells, so-called “repopulation cells”.

The term “Apoptosis” (Greek: the dropping of the leaves in the wind) describes a complex process which is also called programmed cell death and which is used to devitalize tissue and organs. Apoptosis is the most frequent form of cell death in the organism. Apoptosis plays an elementary role for the maintaining of the homeostasis of tissues and organs. The death of individual cells is an essential assumption for the survival of the entire organism, because the origin, organization and preservation of tissues is controlled not only by cell increase and differentiation, but it requires controlled removal of damaged cells. Apoptosis is defined by a great number of morphological and biochemical modifications. These modifications contain the shrinkage of the cell and the condensation of the chromatin, that accumulates itself onto the inner side of the nucleus membrane divided specifically into high-molecular fragments of 50 and 300 kbp and in many cases in even smaller fragments of about 200 bp. Specific protein dividing enzymes like proteases (caspases) are activated to the purposeful removal of essential proteins for example proteins of the cytosceleton. The composition of the plasma membran changes itself and the cell, in particular the cell nucleus shrinks, while the cell organells are remaining relatively long functional. Finally the cell dissembles in apoptotic bodies which are removed by phagocytes or neighbouring cells. It is important that the plasma membran remains intact during apoptosis for the prevention of inflammation reactions.

The term “synthetic material” means every organic and/or anorganic product which is suitable for such purposes. In particular the synthetic material is supposed to increase the mechanical stability of the invention-appropriate organs and tissues.

The invention describes therefore a procedure for the devitalization and preservation of organs and/or tissues until the invention-appropriate devital steady state of organs and/or tissues is achieved, including the sterile harvest and storage of the organ or tissue in a liquid, selected from the group consisting of: sterile water, a crystalloid liquid, a colloidal liquid, a lipid-containing liquid or a combination of the mentioned liquids and also including the invention appropriate—in particular pulsatile—wash out of cell debris, cellular decomposition products as well as soluble substances under pressure application, preferably by application of physiological pressure, using a liquid selected from the group consisting of: sterile water, a crystalloid liquid, a colloidal liquid, a lipid-containing liquid or a combination of the above mentioned liquids. Favoured crystalloid liquids in particular are Bretschneider cardioplegic solution or medium 199 (Seromed). Also favoured is a crystalloid liquid which contains an antibiotic. The storage of the organs is done in a preferred technique in the dark for at least 2 weeks. The storage procedure can also be carried out under light, preferably however under ultraviolett irradiation. This results in the photo oxidation of organs and tissues. The storage in the dark however yields better results.

The harvest of the organ or tissue from dead donors (multi organ donors) is favoured particularly.

In a further, particularly favoured method a multiple rinsing of the respective organs or tissues is done before storage using the same liquid, which is also used for storage. The storage and wash out of cell detritus, cellular decomposition products and soluble substances can be performed using the same liquid. It is necessary, that in the case of tissues a pressure gradient across the tissue is made (for example at hollow organs a transmuraler pressure gradient, that is pressure gradient across the wall of the hollow organ). In the case of organs a pressure gradient is generated between the natural-, organ specific blood, and/or lymphatic vessels and the particular organ to be stored.

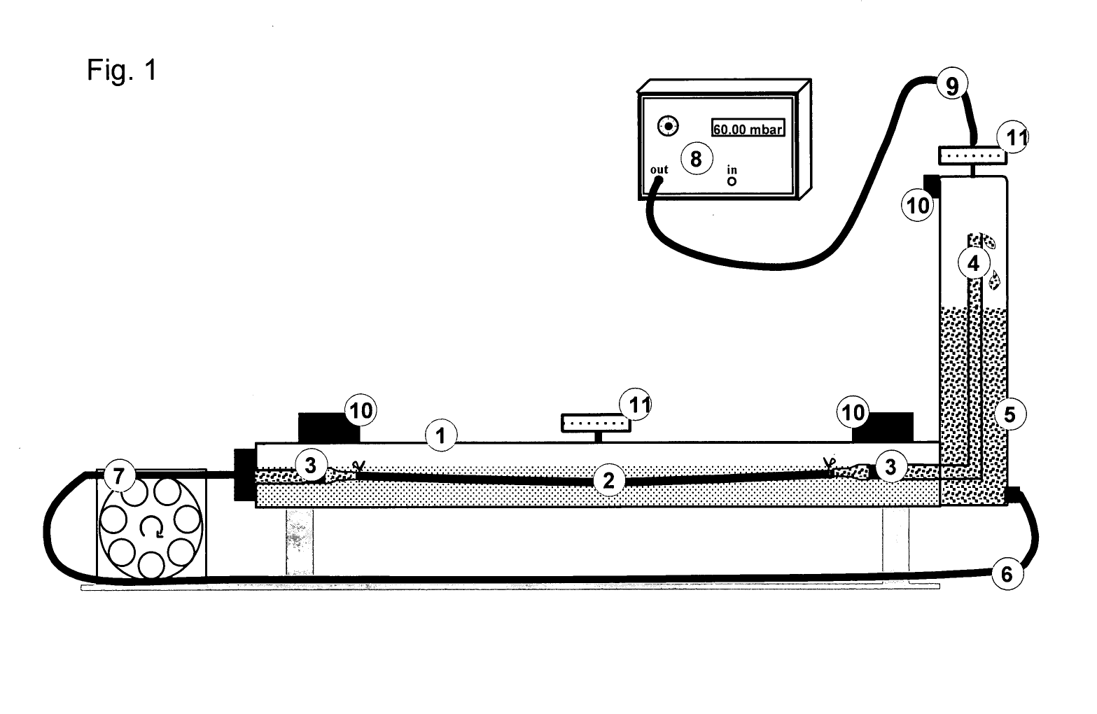

Another design of the invention concerns the repeated outwash of cell debris, cellular decomposition products as well as soluble substances with organ and tissue-specific calibrated pressure waves (dependent on the organs and tissues to be treated). Preferably the storage and outwash of the organs and tissues occurs in a sterile liquid. In a particularly favoured design of the invention the outwash-procedure for hollow organs is performed in the invention-appropriate culture device (FIG. 1).

In another design of the invention-appropriate procedure the storage of the organs and tissues is done for at least 6 months in order to allow the development of a “devital steady state”. The storage occurs particularly preferred under sterile conditions. If veins are treated the particularly preferred invention-appropriate storage time is 6 months. Thereafter the outwash of detritus is done with pulsatile pressure.

In another design the storage of the organs and/or tissues is done with a pH-value between 3 and 9, preferred between 6.9 and 7.8, particularly preferred between 7,0 and 7,5 and with a temperature of 0 to 55° C., preferred 0 to 37° C., particularly preferred however at 4° C.

In a further design the storage of the organs and tissues is done under reduced oxygen pressure, particularly preferred under anaerobe conditions.

In an additional design the invention-appropriate devitalization and/or storage is done with gases, which may be in the fluid form (as for example fluid CO₂), or in gaseous form. The preferred gas is a rare gas.

The invention-appropriate organs and/or tissues can be dried after the invention-appropriate devitalization and preservation. This drying can be achieved by lyophilization or by drying at the critical point after dehydratation.

Organs and tissues that were produced with the invention-appropriate procedure for the devitalization and preservation show in comparison with the native, freshly harvested organs a structurally modified basic framework (extracellular matrix): intermolecular cross-linking and side chain modifications, which are also called “collagen cross linking”. These organs and tissues are ideal prerequisits—even without specific precoating—for a partial or total construction of the specific organs through means of “tissue engineering”. In addition the organs and tissues, as in the case of the preprocessed blood vessels, may also be immediately clinically implanted without any further step.

The invention-appropriate procedure allows the devitalization and preservation of hollow organs, for example blood vessels, blood vessel valves, lymphatic vessels, lymphatic vessel valves, cardiac valves, ureters, spermatic ducts, bronchial tubes and organs such as bladders, livers, kidneys and hearts.

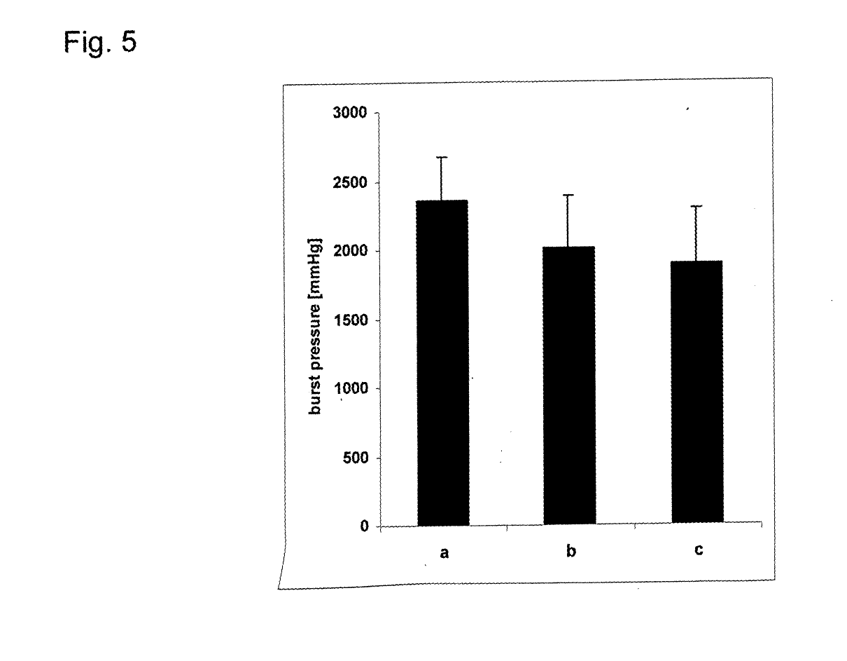

The invention-appropriate procedure is able to achieve significant improvements to traditional procedures. The invention-appropriate organs and tissues demonstrate a significantly higher biomechanical stability, as the same organs and tissues after traditional storage and preservation procedures (for example cryopreservation). The invention-appropriately produced blood vessels show a significantly higher burst pressure (FIG. 5), in comparison with the same hollow organs after cryopreservation. Of extraordinary importance the fact, that the so preprocessed organs and tissues are not or only little antigenic or thrombogenic.

Preferred invention-appropriate hollow organs are, if they are immediately reimplanted, completely deendothelialized and show a staining for keratan sulfate exceeding cell boundaries at otherwise extensive preservation of the extracellular matrix of the specific hollow organs. This concerns in particular the threedimensional preservation of the preserved collagen structures. The slow death of the viable structures during storage and preservation time results even in the death of such cells, that usually survive cryopreservation (for example pericytes, “pericyte like cells”). Antigens, which are expressed by these cells, that are still detectable after cryopreservation (in the case of pericytes and “pericyte like cells” for example the factor which initiates the coagulation cascade (“tissue factor”)), are no longer detecable after the pretreatment with the new procedure.

Another design of the invention intensifies the invention-appropriate procedure for the devitalization of organs and tissues for example with the aid of low molecular substances that induce apoptosis directly or indirectly and/or speeds apoptosis up. In a preferred design a chemotherapeuticum (for example Methotrexat) is used to induce apoptosis leading to acceleration of the speed of devitalization. The acceleration of devitalization for example by means of low molecular substances can happen during the invention-appropriate storage of the organ or tissue or in a previous step. Invention-appropriate substances are any substances that induces apoptosis directly or decreases or increases the interaction of signal molecules, which take place in the induction of apoptosis—in particular the already above-mentioned chemotherapeutica.

Furthermore the invention concerns organs and tissues, in particular hollow organs which are produced with the invention-appropriate procedure. The hollow organs and in particular the vessels that become devitalized and preserved with the invention-appropriate procedure offer ideal conditions for their use as organ matrices (so-called scaffolds) in case of tissue engineering and demonstrate in the case of blood vessels, which have been coated on their luminal surface with patient autologous endothelial cells improved long-term patency rates as compared to uncoated hollow organs and/or vessels. The organs and tissues for the production of the invention-appropriate matrices for the partial or denovo construction of organs and/or tissues are ubiquitously available. The invention-appropriate matrices can be produced without any expenditure, they are—in comparison with artificial surfaces—much less sensitive to infections and less thrombogenic. In addition the production can be performed in highest quality by taught, but not especially educated personnel. In the case of blood vessels the so made invention-appropriate blood vessels show the same operative properties (as for example suturability) as untreated native blood vessels. It is also for the first time possible to implant xenogenic blood vessels in people without any further processing after the invention-appropriate production. There is the possibility for the industrial transfer of the invention-appropriate production in the greatest style without any larger expenditure. The production of a hydrated matrix however is favoured particularly.

The invention-appropriate procedure provides in the case of complex organs, as for example liver and kidney, but also in the case of hollow organs, ideal matrices for the creation or the modification of these organs and tissues through means of “tissue engineering”.

In the case of complex organs, such as liver and kidney, but also in the case of hollow organs it is possible to make ideal matrices available for the denovo synthesis or modification of such organs and tissues by use of the invention-appropriate procedure.

Another invention-appropriate procedure concerns about new culture media that are characterized by the fact that usual culture media such as basal media or complex media become supplemented with autologous (patient autologous) growth factors and/or autologous (patient-autologous) adhesion molecules. Suitable basal media are MEM Eagle, DMEM, Medium 199, MCDB 131, Ham's medium, Iscore, RPMI (available for example through Life Technology, Germany or Seromed, Germany).

The cultivation and propagation of different, partly organspecific cells is made possible by the invention-appropriate procedure and in particular by the invention-appropriate culture media. By use of the invention-appropriate culture media the organspecific differentiation of the used cells is maintained and/or initiated. For example well known problems regarding the propagation and differentiation of liver cells (hepatocytes) known from the use of traditional cell culture techniques become null and void when invention-appropriate culture media and procedures are used. That means, it becomes possible to cultivate the cells of the liver (hepatocytes) without any problems when invention-appropriate culture media supplemented with autologous growth factors are used. The same applies for the cells of the kidney. Cells cultivated under these conditions may be used for the modification or denovo synthesis of organs and tissues, whereby the organs and tissues involved may have been pretreated (for example cryopreservation). Generally these organs and tissues are used as basic frameworks (scaffolds) for their modification through the the above-mentioned cells, through the means of tissue engineering. Ideally by doing this threedimensional constructs are produced which are able to take over the respective functions of the organ or tissue to be imitated completely or in part.

Examples of invention-appropriate hollow organs which can be re-implanted immediately after the invention appropriate devitalization and preservation procedure without any further treatment are human blood vessels such as arteries and veins. Examples for invention appropriate organs which may be used as matrices for the denovo synthesis of organs after the invention appropriate devitalization procedure are among others human blood vessels, livers, kidneys, ureters and bladders.

Particularly favoured are invention-appropriate allo- or xenogenic vessels (arteries, veins, lymphatic vessels) with and without intraluminal lining with autologous endothelial cells.

Furthermore the invention concerns a procedure for the production of matrices for the in part or denovo synthesis of organs, including the steps of devitalization and preservation of organs and/or tissues according to the invention-appropriate procedure and after achieving the invention-appropriate devital steady state, the repopularisation of these organs and/or tissues, for example by reendothelialization. The use of autologous cells (for example endothelial cells) for repopularization is favoured particularly. Favoured in particular is also the use of the new invention appropriate culture media, supplemented with autologous growth factors and/or adhesion molecules.

Hollow organs (for example allogenic and xenogenic vessels and ureters) become reendothelialized after devitalization and preservation of these organs and tissues. It is for example possible, to use xenogenic matrices for the construction of a new vessel and its endothelialization (for example bovine mammary arteries that were subjected to the invention-appropriate procedure).

The invention also concerns about such organs and tissues which have been produced by the invention-appropriate procedure, consisting of devitalization and preservation as well as reendothelialization.

The invention-appropriate hollow organs that became reendothelialized prior to implantation are characterized preferably by a lining of patient autologous endothelial cells on the luminal surface. A particularly favoured method of the present invention describes vessels and their valves, which are lined with recipient autologous endothelial cells on the inner surface (i.e. luminal surface).

Perfusion experiments with invention-appropriate endothelialized donor vessels did not show any differences in endothelial morphology and shear stress stability compared to completely intact, freshly harvested veins or arteries.

The endothelium of all blood vessels, vascular valves and heart chambers is not only characterized by the above-mentioned antithrombogenic features. It represents an immunologically important barrier—if healthy and intact—against the grossmass of immunologically compentent cells of the blood (leucocytes, monocytes, lymphocytes) that pass by without direct contact with the endothelium.

The invention-appropriate procedure allows to produce a completely confluent shear stress resistant endothelialcell layer on the luminal surface of a blood vessel and/or its valves. This layer operates as a complex antithrombogenic and antiinflammatory catalyst in order to prevent thrombembolism of the hollow organs. Organs, that are coated with patient autologous cells, modified or newly constructed, cause not only no immune reactions at their luminal surface, but reduce furthermore possible immunologic reactions of the deeper vessel wall, preventing any clinically relevant rejection reaction. In contrast for example to cryopreserved and autologous endothelialized blood vessels the new process is able to the first time to completely prevent even mild rejection reactions. Additionally the new procedure allows for the first time a clinically relevant repopulation of complex organs (for example liver and kidney). Up til now such a repopularization was impossible due to the antigenicity of the basal frameword of these complex organs.

Furthermore the present invention concerns the clinical use of complex organs which were produced according to the invention-appropriate procedure.

In a particularly favoured invention-appropriate procedure the cell repopulation, in particular the reendothelialization without any precoating of the donor vessels with adhesion factors or serum alone is done by direct seeding and propagation of the cells, which were produced by use of the invention-appropriate culture medium supplemented with autologous growth factors on the inner graft surface. This is not possible with any up to now known cell lining technique.

The invention concerns also methods for the production and use of the new culture media. Invention-appropriate autologous growth factors and adhesion molecules are used for the first time to supplement culture media or for the initial processing of organs and tissues which are further treated by the methods of tissue-engineering. A favoured usage of culture media which are supplemented with autologous growth factors and/or adhesion molecules is the precoating of hollow organs prior the cell seeding procedure with autologous growth factors and/or adhesion molecules. These invention-appropriate culture media is very useful for the culture of cells from the human circulatory system, in particular for the culture of vascular endothelial cells. The use of non-autologous growth factors or recombinant growth factors is often clinically and legaly unacceptable for biotechnological applications, i.e. human usage. This is impressively characterisised by the fact that only a few commercially available culture media are allowed for human use although proven suitability in cell culture. This is due to the fact that human or animal components are usually added to these media, in particular to serum-free media. Possible liability claims prevent the clinical use of complex growth media in human. The invention-appropriate culture media allow the safe culture of human cells.

Examples of basal media, i.e. basal chemically defined culture media for different cell types are: Minimal Essential Medium (MEM) for the culture of adherent mammal cells (Dulbecco R, G. F. Plaque production by the Polyoma virus. Virology. 1959;8:396-397), Medium 199 for the culture of mice-fibroblasts or medium RPMI for the culture of tumor cells. These media differ in the composition of amino acids, vitamins, micronutrients, organic salts and other organic substances which allow the growth of the cultivated cells.

The term basal media is used synonymously to the term “basal chemically defined media”. The term “basal chemically defined media” is used in the tissue culture for culture media of known qualitative and quantitative chemical composition. In contrast to these media, so-called “full media” are supplemented with natural products, such as animal serum.

For the optimal culture of mammal cells basal chemically defined media become supplemented with different sera. Preferably with fetal calf serum (FCS) or Newborn calf serum (NCS) and/or with other growth factors which are not exactly defined (for example endothelial cell growth supplementary: ECGS).

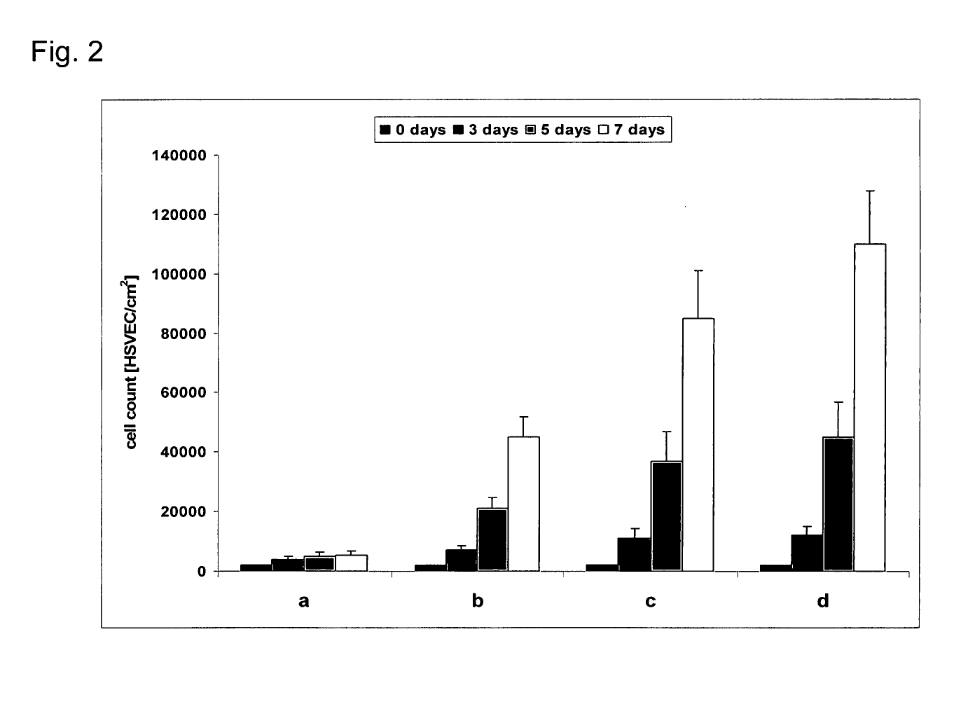

A further aspect of the invention is the supplementation of culture media with autologous growth factors, which were produced in different ways, either alone or in combination with autologous serum or in combination with other non autologous growth factors. It doesn't make any difference whether chemically defined basal media (for example MCDB 131) or so-called full media (for example Gibco HE-SFM) are preferentially used. This results in (1) a faster multiplication of cells, in particular endothelial cells (see FIG. 2), (2) a significant increase in the differentiation of the cells and (3) a increase of the life span of the cells. Another advantage is the absolute clinical non-objection of the new culture media, which allow for the first time the commercialisation of almost all products which are produced according to the methods of tissue engineering. This might be a new milestone for the transfer of organs and tissues which have been produced in vitro for the safe use in human.

### DETAILED DESCRIPTION OF THE INVENTION-APPROPRIATE CULTURE MEDIA

The new culture media are used for the increase of growth, re-modeling processes and reduction of dedifferentiation of vascular cells in cell culture. They are characterised by the fact, that a basal chemically defined medium or a full medium is supplemented with autologous (body-own) growth factors and/or adhesion molecules. The invention-appropriate culture medium contains beside the basal medium (=basal chemically defined medium) or full medium 5-30%, preferably 5-20%, in particular with preference 10-15% autologous serum. Autologous serum means patient-own (obtained by the patient) serum, which contains autologous growth factors and/or autologous adhesion molecules. In addition it is preferably not heat inactivated.

In addition recombinant growth factors can be added to the invention-appropriate culture medium. Examples of suitable recombinant growth factors are bFGF, VEGF, EGF, TGF, “Scatter-factor”, PDGF or a combination of these growth factors.

Autologous growth factors and adhesion molecules can be produced from blood platelets and/or white blood cells. In a favoured manner autologous growth factors and adhesion molecules are produced from concentrated blood platelets. Furthermore the autologous growth factors and adhesion molecules can be manufactured from clotted whole blood by centrifugation. Preferably whole blood is stored for at least for 1 hour at 37° C. or for 6 hours at 4° C. (see FIG. 6).

In a further carrying out form glycosaminoglycane can be supplemented to the invention-appropriate culture medium additionally. Particularly favoured glycosaminoglycanes are heparine, heparinsulfate, chondroitine, chondroitinsulfate, dermatine or dermatinsulfate.

In a particularly favoured carrying out form the invention-appropriate culture medium can become supplemented with transferrine, hydrocortisone, insuline, selenium or albumine additionally.

The invention-appropriate culture medium is suitable for the culture of vascular cells, in particular endothelial cells, perizytes, “pericyte-like-cells” and smooth muscle cells. Furthermore the culture medium is suitable for the culture of non vascular cells, in particular hepatocytes. In addition the culture medium can be used as a nutrition medium in tissue engineering applications. In particular it is suitable as a medium for the precoating of vascular prostheses, cardiac valves and bypass grafts. In a favoured carrying out form the invention-appropriate culture medium can be used as a preservation solution in tissue banking.

In a further carrying out form the autologous growth factors can be obtained by mechanical destruction of body-own tissues. Autologous growth factors may be obtained in particular by chemical and/or biochemical destruction of body-own tissues. Autologous growth factors are particularly favouredly obtained by apoptosis of body-own tissues. Furthermore the destruction of the tissue can be done by use of ultrasound.

In the following favoured procedures for the production of autologous serum are described:

Production of Autologous Serum:

Whole blood is taken from the recipient of the tissue engineered tissue without any anticoagulative substances (as for example citrate). Initiation of the clotting process through activation with artificial surfaces (for example serum tube) or activating substances (for example thrombin). The serum is gained by centrifugation (400 g for 10 minutes).

Production of Autologous Serum Enriched with Autologous Growth Factors From Blood Cells:

Whole blood is taken from the recipient of the tissue engineered tissue without any anticoagulative substances. The initiation of the clotting cascade (see above) results also in the activation of blood cells, in particular blood platelets and leucocytes. The clotting cascade and the simultaneous activation of the blood cells can also be initiated through activating agents (for example 1IE/ml thrombin). It results in a progredient liberation of growth factors (for example VEGF, PDGF, FGF). It is known for example that the liberation of VEGF from activated blood platelets achieves a maximum after 1 h at 37° C. In order to gain most of the growth factors, the clotted blood is stored for one 1 h at 37° C. or at least 6 hours at 4° C. Thereafter the growth factors rich serum is gained by centrifugation.

In a further method for the production of autologous serum with a higher concentration of growth factors from blood cells whole blood anticoagulated with citrate is taken from the recipient and centrifuged to concentrate the corpuscular components (blood cells). Depending on the desired degree of enrichment of the blood cells a part of the plasma is removed. After resuspension of the blood cells and recalcification, the clotting cascade is initiated through artificial surfaces or through physiological activating agents (for example whole blood or thrombin). Growth-factor-rich serum is gained by the methods described above.

In the following the methods of processing autologous growth factors from blood cells is described

Production of Autologous Growth Factor From Platelets:

Citrate blood is taken from the patient. Platelet-rich plasma is gained by cautious centrifugation (315 g for 10 minutes). Liberation of the platelet derived growth factors after recalcification and activation with essentially whole blood (1 ml on 10 ml dice-rich plasma) which initiates the clotting cascade. Concentrated growth factors can be produced by previous concentrating of the platelets, for example to a concentration of 2 million platelets/ml and subsequent activation as described above.

Leucocytes were gained by centrifugation of citrated whole blood and isolation of the so-called buffy-coat. Leucocytes were then acivated, for example with FMLP.

In a further processing method concentrated leucocytes and platelets can be activated together. The isolation of the growth factor rich serum is done by centrifugation described above.

Isolation of Autologous Growth Factors of Blood Cells and Other Tissues Through Mechanical Desintegration of the Cells:

In a favoured carrying out form the lysis of the cells occurs through complement activation or apoptosis.

Isolation of Concentrated Autologous Serum or Concentrated Growth-Factor-Rich Serum:

Optionally this invention-appropriate serum can be concentrated with standard concentrators by revocation of water (for example dextranomers, polyacrylic amide). Dextranomers and polyacrylic amide concentrators are commercially available (Sephadex from Pharmacia, Biogel P from Bio-Rad Laboratories). Alternative concentrators as silica gel, zeolite, dextramine, alginate gel, “crosslinked” agarose can be used as well.

The obtained mixture can also be dialyzed against physiological solutions (Hank's salts, Earle's salts, basal media).

The additionally supplementation of basal chemically defined media with heparine, insuline, hydrocortisone, transferrin and selenium next to autologous serum and autologous growth factors is growth promoting. In particular heparine is an important co-factor.

The following describes different applications of the invention-appropriate cultivation apparatus:

The cell lining of invention-appropriate hollow organs can be performed by use of already known bioreactors. The invention-appropriate cultivation apparatus (bioreactor) (FIG. 1) is suited in particular for this task. The use of the invention-appropriate bioreactor is accompanied by the following advantages:

There is a constant variable pressure gradient across the vein wall. In addition there is transport of medium across the vein wall which is used for the nutrition of seeded endothelial cells and—if wanted—of other cells which have been seeded in the vein wall. In addition antigens of the vessel wall will be washed out into the outer medium. In addition the invention-appropriate bioreactor allows a continuous perfusion ot the endothelialized hollow vessels if it seems necessary to support certain stages of differentiation of the cells. It results in a clearly increased synthesis of extracellular matrix proteins which supports the shear stress stability of the seeded endothelial cell layer of the endothelialized hollow organs. This device is simple, easy to handle, cheap and a safe tool for any endothelialization procedure of hollow organs of every kind.

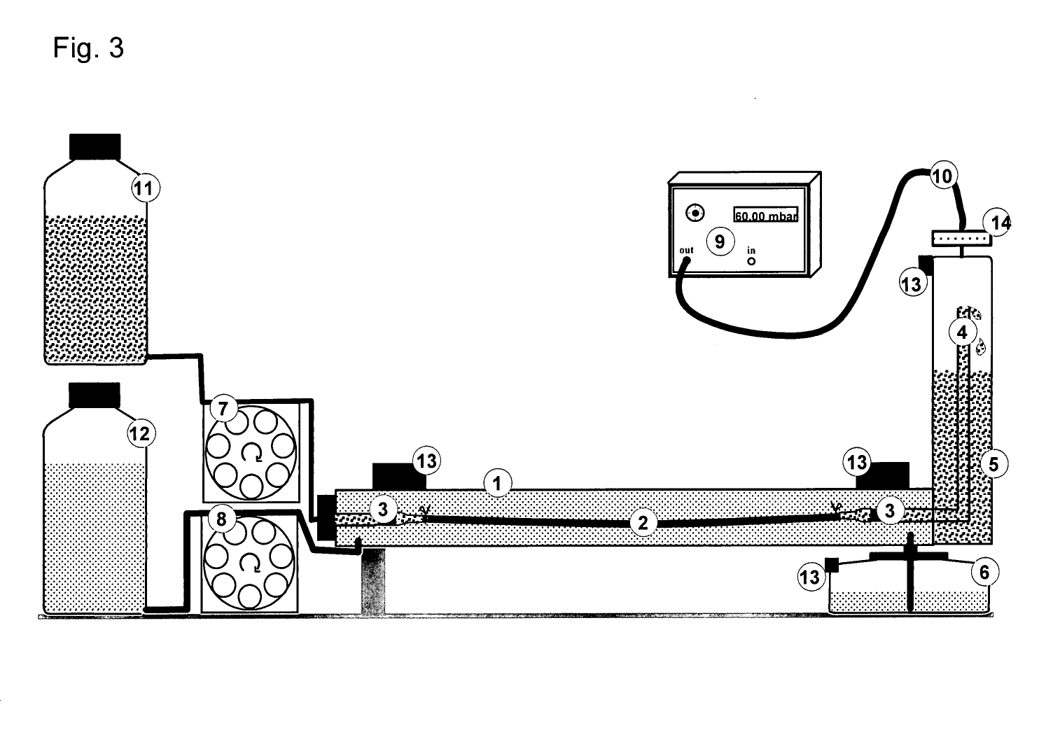

Furthermore the invention-appropriate bioreactor is suitable also for following processes:
for repopulation of prosthetic and organic material, in particular for the reendothelialization with and without perfusion of the hollow organ.
in modification (FIG. 3), for the outwash of unwanted soluble and non-soluble substances from prosthetic and organic material, in particular from hollow organs. The outwash is done by application of a transmural pressure gradient.

It is possible to apply the invention-appropriate procedure for the production of matrices for the partial or denovo synthesis of organs and tissues to all natural and artificial hollow organs and their components, for example to natural blood vessels, blood vessel valves, lymphatic vessels, lymphatic vessel lids, ureters and bladder, spermatic ducts, bronchial tubes, the heart and in particular cardiac valves.

During the production of so-called biological cardiac valves of xenogenic materials (for example from bovine pericardium) the raw material used is often fixed with so-called crosslinking agents (for example glutaraldehyde). By doing so the possible storage duration of the raw materials extends. In the next step the raw materials are placed onto so-called “stents” in order to achieve a biological form and biomechanical stability. These “stents” serve also as supports for the anchoring of the surgical sutures during the implantation. It is known that there are chronic immunological processes after implantation of such cardiac valves which finally results in degeneration of the affected cardiac valve. The stability of such cardiac valves after implantation in people is known to be no longer than 15 years. After that a replacement of the cardiac valve must be carried out in a redo operation with a significantly higher operation risk for the affected patient. Structure antigenes of the initial tissue employed to the cardiac valve production are causal for these immunologic processes. If the invention-appropriate raw materials are used such antigenic structures become completely eliminated resulting in increased life spans of biological cardiac valves. Invention-appropriate cardiac valves can be implanted without any further treatment. It is also possible to further procure these valves with any other preservation solution or technique which is already in use for the production of biologic heart valves.

We demonstrated, that there is no difference of the mechanical stability of coated or uncoated invention-appropriate hollow organs after 12 month of storage or freshly harvested donor veins (Burst pressure test and histological examinations of the extracellular matrix). The invention-appropriate vessels showed however a higher mechanical stability than cryopreserved vessels (FIG. 5).

The preferred usage of the invention-appropriate procedure is the production of matrices for partial or total synthesis of organs and tissues from donor vessels (veins or arteries), as well as xenografts. A special advantage of the procedure is the possibility of antiviral treatment of the vessels prior to coating. This is possible since the vessel wall of the invention-appropriate vessels shows a by far higher mechanical stability than for example the wall of a cryopreserved vessel.

In a favoured invention-appropriate technique the re-popularization of these organs with cells occurs after invention-appropriate outwash in an organ-specific threedimensional rotation equipment. Such rotation equipment is commercially available (Rotary Cell Culture System™, Synthecon Inc, USA).

It is also possible to use vessels in an invention-appropriate manner, which are reendothelialized with patient autologous endothelial cells, whereby the endothelial cells are of different origin (for example peripheral blood, bone marrow, fat tissue, gene-technically modified or produced endothelium, xenogenic and gene-technically modified xenogenic endothelium).

In addition patient-autologous epithelium can be produced gene-technologically in such a way that epithelium is produced which imitates the surface- and immunological properties of patienten-autologous epithelium.

In another invention-appropriate method (see detailed description in examples 15-17) precoating of artificial surfaces is performed with cells, which are able to produce extracellular matrix. In a second step surfaces, which have been treated in this manner, are further procured by the invention appropriate methods.

Further procurement of surfaces which have been produced in this manner may be done by the methods or processes of tissue engineering or the methods or processes of anorganic or organic chemistry (for example by chemical insertion of antithrombotic features. Furthermore it is possible to treat the surfaces with supporting substances, such as adhesion molecules.

In another method the invention-appropriate hollow organ is in addition enclosed on the exterior surface from a coat of a synthetic material. This synthetic coat can consist of resorbable material, for example of synthetic polyglyconacid. Hollow organs which are surrounded from a coat of synthetic material show the advantage that they are stabilized for several months.

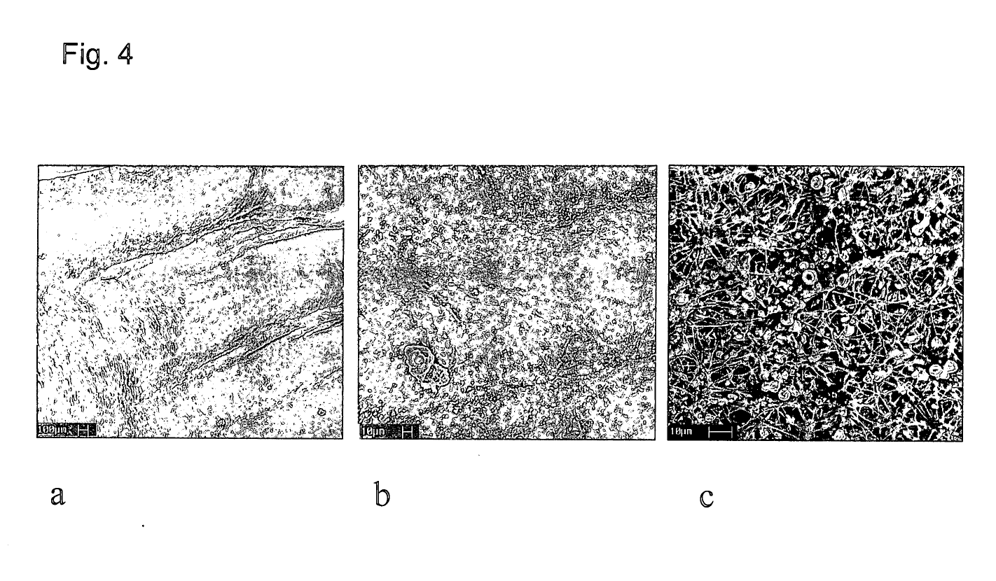

In Comparison with up to now published results regarding to the antithrombogenicity of connective tissue the invention-appropriate organs and tissues show a significantly reduced thrombogenicity. FIG. 4a and b show an invention-appropriate vein that was explanted 16 hours after implantation into a patient. The vein shows a completely smooth surface without any adhesion of fibrin, Platelets, and leukocytes. The patient autologous arteries and veins which had been employed during this operation as well were all covered on the inner surface with adhesion deposits of platelets and leucocytes and (FIG. 4C) were completely thrombosed.

The invention-appropriately produced organs can be employed in the entire field of medicine and veterinarian medicine, in surgery, in particular in heart and vascular surgery. Uncoated or coated invention-appropriate vessels find special use as aortocoronary bypass grafts in patients with coronary heart disease and as vessel transplants for vessel reconstructions of any kind. This concerns for example the peripheral arterial occlusion disease, aneurysmatic changes in the vessel wall that require replacement of the respective vessels as well as all cardiac and vascular redo operations. In particular these vessels are the ideal conduit for use in infected body areas. Further indications for use of such vessels represent a great number of congenital deformations (for example any form of shunt operations). In addition such vessels may be used for basic research as for example of arteriosclerosis research or permeability studies of pharmaceutics. The possibility to be able to implant uncoated vessels at any time without any further precurement is of special interest. This also allows the in hospital storage of these vessels in the same manner as the usual storage of artificial protheses. The invention-appropriate manufacturing-process makes therefore for the first time in the history of medicine an alternative bypass for use in cardiac surgery available, that can be used at any time.

The figures are used for the explanation of the invention.

FIG. 1 shows a bioreactor for the invention-appropriate procedure: it consists exclusively of biologically inert, sterilizeable parts. By use of this device a variable pressure gradient across the vein wall can be built up. Furthermore the vessel can be perfused under pressure by the aid of a pump.

The bioreactor consists of a culture vessel filled with medium (1) in which the hollow organ is (for example a vein (2)) transferred. The lumen of the two vein ends is connected with the two outflows of the culture vessel by means of two adapters (3). One adapter is connected with a computer controlled peristaltic pump (7). The other adapter ends at an stock or dump vessel (5) with a riser tube (4). If the vessel (5) represents a dump vessel, the hose (6) must be connected to a stock vessel. The pressure gradient Δp (dependent on the riser tube (4) and pressure transducer (8)) is tuned after desired pressure gradient about the vessel wall. If the pressure educated by the stalk (4) is sufficient, the apparatus can also be used without pressure transducers (8). Through the peristaltic pump (7) it is possible to perform a change of medium in the inside lumen of the vein or a continuous/discontinuous perfusion of the vessel (2). Pressure pipe (9), entrance ports (10), sterile filters (11).

FIG. 2 shows the growth behavior of cultivated human saphenous macrovascular endothelial cells under different culture conditions (daily 50% media change).
a) Cultivation of the cells in medium MCDB 131 with 20% pool serum.
b) Cultivation of the cells in medium MCDB 131 with 20% autologous serum.
c) Cultivation of the cells in medium MCDB131 with 20% pool serum+10 ng/ml rbFGF.
d) Cultivation of the cells in medium MCDB131 with 20% of invention-appropriate growth factor rich autologous serum (of platelet-rich plasma: 2 million platelets/ml).

It is clear that the invention-appropriate medium (d) offers the best culture conditions for human endothelial cells by far.

FIG. 3 shows a modification of the bioreactor shown in FIG. 1 for the invention-appropriate pressure-dependent flushing system of a hollow organ. In this case no media recirculation occurs (compare FIG. 1). The stock vessel I (11) includes the liquid which is applied under pressure (dependent on the riser tube (4) and pressure transducer (9)) to the inner lumen of the hollow organ (2) with aid of a pump (7) and collected in the dump vessel I (5). The stock vessel II (12) contains the liquid that is used, with the aid of the pump (8), to circulate the outer medium of the hollow organ (2). The liquid, including the via the wall of the hollow organ filtered liquid is then collected in the dump vessel II (6). Pressure pipe (10), entrance ports (13), sterile filter (14).

FIG. 4 shows a invention-appropriate vein after implantation in comparison with an autologous native vein. FIG. 4a and 4b shows the invention-appropriate vein that was taken by autopsy 16 hours after implantation into a patient. In histological evaluation of the inner surface of the vein there was a completely smooth surface without any adhesion of fibrin, platelets and leucocytes. In contrast FIG. 4c shows the inner surface of the autologous native vein which is also used as bypass material during this operation. It was completely occluded by thrombosis and showed in histological evaluation of the inner surface adhesions of fibrin, platelets and leucocytes.

FIG. 5 shows the burst-pressures of a) freshly harvested veins, b) cryopreserved veins immediately after thawing and c) invention-appropriate veins 12 months after invention-appropriate storage.

The following examples explain the invention and are not to be understood as limiting.

### EXAMPLE 1

### Devitalization and Preservation of Blood Vessels

Donor veins are taken according to traditional technique by the organ donor sterilely. These vessels are examined in the operating room for their integrity. Possible side branches of the veins become ligated with suture material (for example Ethibond 4/0) in usual technique. The vessels are rinsed multiple with cristalloid solution (for example Bretschneider cardioplegic solution or medium 199 (Seromed)) and transferred into a small tube from approx. 1 cm caliber (a sterile epoxy tube or a special developed glass tube can be used). The vessel is filled with medium 199 and stored in the dark at 4° C. Optionally the veins can also be filled with medium 199, shut at both ends for example with vessel tie-clips and stored then in medium 199. This has the advantage that the vessel does not collapse if it is withdrawn from its container. The storage should last at least 6 months. The vessel after a storage time of more than 24 months is still suitable for its invention-appropriate use without any limitation. After verification of sterility by microbiological tests and invention-appropriate flushing of the vessel after withdrawal from the storage container the vessel can be implanted immediately. The inner surface of the hollow organ can be smoothed before the implantation mechanically. To do so a standard balloon catheter (Fogarty-catheter) can be pulled through the hollow organ. This procedure is recommended since storage-conditional unevenness of the surface can not be excluded.

### EXAMPLE 2

Invention-appropriate preparation of donor veins in accordance with example 1 with a storage time of 6 months. A devitale “steady state” is reached by this procedure.

### EXAMPLE 3

Invention-appropriate procedure in accordance with example 2 with a pH-value of 7,0 and a temperature of 18-22° C.

### EXAMPLE 4

### Patient-Autologous Endothelialization of Invention-Appropriate Modified Veins

Approx. 500 ml of whole blood is taken from the patients prior to the operation without any anticoagulative substances. Whole blood is then stored at 4° C. for 24 hours and then centrifuged to gain serum. Afterwards the serum is deep-frozen up to further use.

In a first operation a 5 cm long autologous vein remnant is taken from the recipient in local anesthesia. The cell isolation and further propagation of endothelial cells is done according to usual cell culture techniques (Jaffe E A, Nachman R L, Becker C G, et al. Culture of human endothelial cells derived from umbilical veins. Identification by morphologic and immunologic criteria. J Clin Invest 52:2745-56, 1973). Medium 199 (Seromed) supplemented with 20% autologous serum and 2 ng/ml recombinant bFGF (basic fibroblast growth factor) can be used as culture medium for example. After a sufficient cell number for the endothelialization procedure is reached, a invention-appropriate donor vein is taken from its storage container. The vein becomes directly without any pretreatment, filled with the endothelial cell suspension (see later in this chapter) or is pretreated by incubation of the inner surface of the vein with patient-autologous serum in a incubator for 12 to 24 hours at 37° C. For this purpose both ends of the vein are connected with an adapter which is closed by use of a reusable stuffing. After removal of the serum by opening the stuffing the precoated vein is filled with a defined cell number (80.000-120.000 cells/cm² inner graft surface) of patient-autologous endothelial cells and locked through reintroduction of the stuffing. For homogenous seeding of the endothelial cells to the inner surface the vein becomes rotated for several hours in a rotating device (Kadletz M, Moser R, Preiss P, et al. In vitro lining of fibronectin coated PTFE grafts with cryopreserved saphenous vein endothelial cells. Thorac Cardiovasc Surg, 35 Spec No 2: 143-147, 11/1987) in a incubator at 37° C. After homogenous seeding the vein is taken from the rotating device and transferred into the specific bioreactor (see FIGS. 1 and 3).

### EXAMPLE 5

### Patient-Autologous Endothelialization of Invention-Appropriate Modified Veins Under Use of Patient Autologous Growth Factors and Adhesion Molecules:

The endothelialization of invention-appropriate preprocessed allografts was carried out according the procedure described in example 2. In contrast to example 2 invention-appropriate autologous growth and adhesion-factor-rich serum was used in the pretreatment of the allografts. For the cultivation of the cells culture medium substituted with invention-appropriate autologous growth-factor-rich serum (MCDB 131+20% invention-appropriate serum) is used.

Production of the autologous growth and adhesion-factor-rich serum:

Approx. 500 ml of whole blood supplemented with anticoagulative substances favouring citrate is taken from the patient prior to the operation. Isolation of platelet-rich plasma (plasma with concentrated platelets) through cautious centrifugation (315 g for 10 minutes). Liberation of the autologous growth factors by degranulation of the platelets after recalcification and activation with whole blood (1 ml whole blood for 10 ml platelet-rich plasma). Concentrated growth factors can be produced by previous concentrating of the platelets, for example to a concentration of 2 million platelets/ml and subsequent activation as described above.

Optionally the invention-appropriate serum can be concentrated with standard concentrators by revocation of water (for example dextranomers, polyacrylic amide). Dextranomers and polyacrylic amide concentrators are commercially available (Sephadex from Pharmacia, Biogel P from Bio-Rad Laboratories). Alternative other concentrators as silica gel, zeolite, dextramine, alginate gel, “crosslinked” agarose can be used.

The obtained mixture can also be dialyzed against physiological solutions (Hank's salts, Earle's salts, basal media).

### EXAMPLE 6

### Patient-Autologous Endothelialization of Invention-Appropriate Preprocessed Xenografts:

The endothelialization of invention-appropriate preprocessed xenografts is carried out according to the procedure described in example 2 or 3.

### EXAMPLE 7

### Patient-Autologous Endothelialization of Another Vessel, for Example an Artery

The endothelialization process of an artery is carried out in the same way as shown by the endothelialization procedure of a vein described in example 2 or 3.

### EXAMPLE 8

### Epithelialization of Another Hollow Organ, for Example an Ureter.

The epithelialisation of an ureter is described correspondingly to the endothelialization procedure shown in the example 2 with the difference, that instead of endothelium urothel is used.

### EXAMPLE 9

### Endothelialization Procedure with Isolated Endothelial Cells From Other Origin

Endothelialization procedure as described in example 2. The isolation of the corresponding endothelial cells is done from peripheral blood, bone marrow and abdominal fat according to well known methods. The isolation of that kind of endothelial cells has a clear benefit for patients since these procedures are also available for such patients which do not have any sufficient vascular substrate for the isolation of autologous endothelial cells. In addition these procedures are less invasive for the patient.

The following examples refer to the use of the invention-appropriate media (media supplemented with autologous growth factors and adhesion molecules) in terms of cell culture technique for tissue engineering.

### EXAMPLE 10

### Isolation and Cultivation of Human Macrovascular Endothelial Cells (From Veins and Arteries):

The isolation is done as described above according to the method Jaffe et al. The cultivation of the cells is done preferably in medium MCDB 131 with 20% autologous growth factor rich (from platelets) serum (2×10⁶ platelets/ml) substituted in addition with Heparin (50 μg/ml).

### EXAMPLE 11

### Isolation and Cultivation of Human Smooth Muscle Cells From Media Pieces of the Aorta

Primary culture of aortic smooth muscle cells can be obtained by at least two methods:
1. outgrowth of smooth muscle cells from explanted pieces of the aortic media
2. enzymatic dispersion of the aortic media. Method 2 is favoured due to higher cell gains.

The media of pieces of the human aorta is separated from the intima and adventitia surgically. The separated media contains no fragments of intima or adventitia. The media is mechanically dissected in 5 mm pieces and subsequent incubated with a proteolytic solution (0.05% elastase type III, 0.225% collagenase, 1% human albumine in phosphate buffered saline). One gram tissue is digested with at least 10 ml of enzyme solution. The tissue is incubated at 37° C. until practically complete dispersion, which usually required 3-5 h. After complete digestion the cell suspension is filtered through a nylon mesh (50 μm), centrifuged (190 g, 10 min) and resuspended in autologous culture medium (M199+20% autologous growth-factor-rich serum). Cells were seeded at a density of 10⁴ cells per 1 cm² in tissue culture plastic and cultured at 37° C. in a humidified atmosphere of 5% CO₂ and 95% of air.

### EXAMPLE 12

### Isolation and Cultivation of Humane Keratinocytes

For the isolation of humane keratinocytes, skin remnants from operations can be used (for example circumcision). For the transportation of the skin remnants to the laboratory a basal medium (for example DMEM) substituted with antibiotics (for example Gentamicin 50 ng/ml) for the reduction of the natural skin flora and prophylaxis of a secondary infection is used.

At first hairs and necrotic tissue is removed from the skin remnant. Afterwards that fat tissue and vessels of the subcutis are separated cautiously. For the dispersion of the keratinocytes the preparated skin is placed in a trypsin/EDTA-solution (0.25%/0.2%) for 18 hours at 4° C. After 18 hours of incubation the enzyme action is visible by the fact that the skin becomes a jelly-like state. In order to wash out the remaining trypsin/EDTA solution, the skin is rinsed with phosphate buffered saline. After that the dissociated tissue is removed from the skin and suspended in culture medium. This cell suspension is filtered through a sterile mull compress (or a 50 μm nylon mesh) to remove tissue fragments and debris. The cell suspension is centrifuged (190 g, 10 min) and resuspended in autologous culture medium. Then the cells are seeded in tissue culture plastic. In a humidified atmosphere of 5% CO₂ and 95% of air and 37° C. temperature the primary culture is kept for 24 hours in the incubator. After 24 hours of incubation in which the cells can adhere to the culture dish the medium is changed. After that the culture medium is changed every 3 days.

As a culture medium the culture medium MCDB 153 (Boyce S T, Ham R G. Calcium-regulated differentiation of normal human epidermal keratinocytes in chemically defined clonal culture and serum-free serial culture. J. Invest Dermatol. 1983;81:33s-40s) substituted with insuline (5 mg/l), hydrocortisone (1.4 μM, 0.5 mg/l), ethanolamine (0.1 mM), phosphoethanolamin (0.1 mM) with 10% autologous serum and 10% autologous growth factors from platelets (2×10⁶ platelets/ml) can be used.

### EXAMPLE 13

### Isolation and Cultivation Human Dermal Fibroblasts

After isolation of the keratinocytes the remaining skin is given into a culture bottle with autologous growth-medium (M199 with 10% autologous growth-factor-rich serum). After few days incubation in the incubator (5% CO₂, 37° C.) fibroblasts growths out from the skin. After sufficient outgrowth of fibroblasts from the skin, the remaining skin is removed. Change of culture medium is performed every 3 days.

### EXAMPLE 14

### Cultivation of Human Hepatocytes

Isolation of human hepatocytes is performed according to the method of Berry et al. (Berry M N et al., High-yield preparation of isolated hepatocytes from rat liver. In Laboratory Techniques in Biochemistry and Molecular Biology, vo. 21 (ed. R H Burdon and P H van Knippenberg), pp. 15-58. Elsevier: Amsterdam, New York, Oxford, 1991).

The cells were seeded in a density of 1.6×10⁵ cells/cm² in culture bottles. As a culture medium medium William's E medium (Gibco, Grand Island, N.Y., USA) substituted with 15% autologous growth factor- and adhesion molecule-rich serum (growth factors from 2×10⁶/ml platelets and 7 ×10⁵/ml leucocytes), 25 mM HEPES, 5 μg/ml insuline, 0.5 μg/ml hydrocortisone, 5 μg/ml transferrin, 100 U/ml penicillin, 100 μg/ml streptomycin is used. 50% of the culture medium is changed every 24 hours.

### EXAMPLE 15

### Coating of an Artificial Surface (Here PTFE Prosthesis, Ø 4 mm) With Fibroblasts and Subsequent Invention-Appropriate Aftertreatment.

Isolation and cultivation of fibroblasts is described in example 13. The sterile PTFE-prosthesis to be coated is inserted into autologous serum. The inner lumen of the prosthesis must be wetted completely with the serum. The prosthesis is stored then for approx. 12 hours at 37° C. Then the prosthesis is taken and filled with a cell suspension of fibroblasts (100000 cells/cm² inner prosthesis surface). The prosthesis is now rotated for 6-10 hours in a rotating device (see also example 4) guaranteeing a homogenous seeding of the cells. Then the coated prosthesis is transferred into a bioreactor and cultivated for 4 weeks until a layer of extracellular matrix of a thickness of at least 10 μm, fitting to the inside lumen firmly, is formed. Then the coated prosthesis is treated invention-appropriate to reach the devitale steady state. After invention-appropriate treatment of the prosthesis it can be implanted immediately or further procured within the framework of tissue engineering.

### EXAMPLE 16

### Seeding and Coating of an Artificial Surface (Here Polyurethane Prosthesis, Ø 4 mm) With Cells of Subintimal Origin and Subsequent Invention-Appropriate Aftertreatment.

The isolation of subintimal cells is performed from vessels after the proteolytic isolation of the endothelial cells (see example 10). The subintimal cells are detached from the vessel by a further subsequent 15-minute proteolytic desintegration of the remaining cells (=subintimal cells) on the inner surface of the vessels by use of the same proteolytic solution (collagenase). After proteolytic dispersion of the subintimal cells the cells are collected by rinsing the vessel. The cells are cultivated as described in example 13. The further procedure is done according to example 15.

### EXAMPLE 17

### Endothelialization of a Invention-Appropriate Preprocessed Coated Artificial Surface (Here PTFE Prosthesis, Ø 4 mm).

PTFE prosthesis were prepared according to example 15. After the devital steady-state is reached the treated PTFE prosthesis is endothelialized with the method shown in example 4.

1. Procedure or process for devitalization and preservation of organs and/or tissues, comprising the following steps:
a. sterile harvest and storage of the organ or the tissue in a liquid selected from the group consisting of: sterile water, a crystalloid liquid, a colloidal liquid, a lipid-containing liquid or a combination of the mentioned liquids, until the devitalization is achieved,
b. the outwash of cell-fragments, cellular decomposition products (debris) as well as soluble substances under pressure with a liquid, selected from the group consisting of: sterile water, a crystalloid liquid, a colloidal liquid, a lipid-containing liquid and a combination of the mentioned liquids.

2. The procedure or process of claim 1 wherein the sterile harvest of the organ and/or tissue is performed from dead people (multi organ donors).

3. The procedure or process of claim 1 wherein the storage occurs for at least 2 weeks, preferably for 6 weeks, in particular preferred however for 6 months in the dark.

4. The procedure or process of claim 1 wherein the storage occurs under sterile conditions.

5. The procedure or process of claim 1 to 4, wherein the storage liquid is a crystalloid liquid.

6. The procedure or process of claim 5 wherein the crystalloid liquid is Medium 199 (Seromed).

7. The procedure or process of claim 5 wherein the crystalloid liquid is cardioplegic solution (Bretschneider solution).

8. The procedure or process of claim 5 wherein the crystalloid liquid is supplemented with antibiotics.

9. The procedure or process of claim 1 to 7 wherein the procedure contains a multiple rinsing of the organs and/or tissues before the storage in the same liquid in which the storage occurs.

10. The procedure or process of claim 1 to 8 wherein the storage and the outwash of the organs and/or tissues occurres with the same liquid.

11. The procedure or process of claim 1 to 9 wherein the storage is done at a pH-value from 3 to 9.

12. The procedure or process of claim 10 wherein the storage is done at a pH-value from 6.9 to 7.8.

13. The procedure or process of claim 10 wherein the storage is done at a pH-value from 7.0 to 7.5.

14. The procedure or process of claim 1 to 12 wherein the storage is done at a temperature of 0 to 55° C.

15. The procedure or process of claim 13 wherein the storage is done at a temperature of 0 to 37° C.

16. The procedure or process of claim 13 wherein the storage is done at a temperature of 4° C.

17. The procedure or process of claim 1 to 15 wherein the storage is done under reduced oxygen pressure.

18. The procedure or process of claim 16 wherein the storage is done under anaerobe conditions.

19. The procedure or process of claim 1 to 15 wherein the storage is done with gases (in the fluid or gaseous stage).

20. The procedure or process of claim 18 wherein the gas is a rare gas.

21. The procedure or process of claim 1 to 20 wherein the washing out occurs pulsating.

22. The procedure or process of claim 21 wherein the washing out of cellular particles, cellular decomposition products, as well as soluble substances is done repeatedly.

23. The procedure or process of claim 22 wherein the washing out is done at least twice, preferably at intervals of 6 weeks.

24. The procedure or process of claim 1 wherein invention-appropriately treated organs and tissues are dried after devitalization and preservation.

25. The procedure or process of claim 1 wherein the organs are hollow organs.

26. The procedure or process of claim 1 wherein the washing out is performed by use of a cultivation apparatus comprising a culture vessel which is filled with a liquid (1), two adapters (3) that are connected with the two outflows of the culture vessel, a hose, that is connected with a pump and a further hose that ends at a stock or dump vessel (5) wherein the pressure gradient Δp is dependent on the riser tube (4) and pressure transducer (8).

27. The procedure or process of claim 1 wherein the washing out is done by use of a cultivation apparatus in accordance with FIG. 1.

28. The procedure or process of claim 1 wherein the organs and tissues are selected from the group consisting of: Blood vessels, blood vessel valves, lymphatic vessels, lymphatic vessel valves, ureters, bladders, spermatic ducts, bronchial tubes, livers, kidneys, hearts and cardiac valves.

29. Organs and tissues produced by the procedure or process of claim 1 to 27.

30. The procedures or processes for the production of matrices for the partial or denovo synthesis of organs and/or tissues comprising the following steps:
a. devitalization and preservation of organs and/or tissues according to the procedures or processes of one of the claims 1 to 27,
b. cell-repopulation of the organs and tissues, preferably through re-endothelialization.

31. The procedure or process of claim 29 wherein the organs are hollow organs.

32. The procedure or process of caim 30 wherein the hollow organs are selected from the group consisting of: allogenic vessels, to xenogenic vessels and ureter.

33. Organs produced which are produced according to one of the claims 29 to 31.

34. The procedure or process of claim 29 wherein the cells used for re-population are autologous cells, for example endothelial cells.

35. The procedure or process of claim 29 wherein the re-endothelialization is done by the seeding of cells on the intraluminal surface of the hollow organs.

36. The procedure or process of claim 29 wherein a precoating of the hollow organs with adhesion molecules is performed before cell seeding.

37. The procedure or process according to claim 29, characterized in that the hollow organ is precoated with autologous serum before seeding of the cells.

38. The procedure or process according to claim 30, characterized in that the hollow organ is precoated with autologous growth and adhesion factor rich serum before seeding of the cells.

39. The procedure or process according to claim 30, further comprising natural and artificial hollow organs selected from the group consisting from: blood vessels, blood vessel valves, lymphatic vessels, lymphatic vessel valves, ureters, bladders, spermatic ducts, bronchial tubes, hearts and cardiac valves.

40. Use of the tissues or organs, available through the procedure or process according to one of the claims 1 to 28 in the medicine and veterinarian medicine.

41. Use of the vessels, available through the procedure or process according to one of the claims 1 to 28 in the cardiac and vascular surgery.

42. Use of the vessels, available through the procedure or process according to one of the claims 1 to 28 as an aortocoronary bypass or as a vascular transplant in vascular reconstructions.

43. Use of the vessels, available through the procedure or process according to one of the claims 1 to 28 in peripheral arterial disease, aneurysms, redooperations in cardiac and vascular surgery and in the case of innate deformations of the vascular system.

44. Tissues and organs, available through the procedure or process according to one of the claims 1 to 28, characterized in that the tissue and organ is in addition surrounded by a coat of a synthetic material.

45. Tissues and organs, available through the procedure or process according to one of the claims 1 to 29, characterized in that the tissue and organ is in addition surrounded by a coat of a synthetic resorbable material.

46. Tissues and organs, available through the procedure or process according to one of the claims 1 to 28, characterized in that the tissue and organ is in addition surrounded by a coat of a synthetic resorbable material, comprising polyglycon acide.

47. Cultivation device (bioreactor) for the use in a procedure or process according to claim 1, comprising a culture vessel filled with a solution (1), two adapters (3) which are connected with the two outflows of the culture vessel, a hose, that is connected with a computer controlled peristaltic pump and a further hose that ends at an stock or dump vessel (5). The pressure gradient Δp is dependent on the riser tube (4) and pressure transducer (8).

48. Culture medium for the increase of growth, remodeling processes and reduction of dedifferenziation of vascular cells in tissue culture, characterized in that autologous growth factors and/or adhesion molecules are added to a basal chemically defined medium or to a full medium.

49. Culture medium according to claim 48, characterized in that the growth factors and/or adhesion molecules are added in autologous, not heat inactivated serum.

50. Culture medium according to claim 48, comprising 5-30% of autologous serum.

51. Culture medium according to claim 48, comprising 5-20% autologous serum.

52. Culture medium according to claim 48, comprising 10-15% autologous serum.

53. Culture medium according to any of the claims 48 to 52, characterized in that additionally recombinant growth factors are added.

54. Culture medium according to claim 48, characterized in that autologous growth factors and adhesion molecules are produced from platelets.

55. Culture medium according to claim 48, characterized in that autologous growth factors and adhesion molecules are produced from leucocytes.

56. Culture medium according to claim 48, characterized in that autologous growth factors and adhesion molecules are produced from platelets leucocytes.

57. Culture medium according to claim 48, characterized in that autologous growth factors and adhesion molecules are processed from autologous clotted whole blood by centrifugation technique.

58. Culture medium according to claim 57, characterized in that the autologous whole blood is stored for at least 1 hour at 37° C.

59. Culture medium according to claim 57, characterized in that the autologous whole blood is stored for at least for 6 hours at 4° C.

60. Culture medium according to claim 54 and 57, characterized in that the autologous growth factors and adhesion molecules are gained from enriched (concentrated) platelets.

61. Culture medium according to claim 53, characterized in that the recombinant growth factor is bFGF, VEGF, EGF, TGF, Scatter-factor, PDGF or the combination of these growth factors.

62. Culture medium according to any of claims 48 to 61, further comprising glycosaminoglycane.

63. Culture medium according to claim 62, characterized in that the glycosaminoglycane is heparine, heparinsulfae, chondroitin, chondroitinsulfate, dermatin or dermatinsulfate.

64. Culture medium according to any of claims 48 to 63, further comprising transferrin.

65. Culture medium according to any of claims 48 to 63, further comprising hydrocortisone.

66. Culture medium according to any of claims 48 to 63, further comprising insuline.

67. Culture medium according to any of claims 48 to 63, further comprising albumine.

68. Culture medium according to any of claims 48 to 63, characterized in that the culture medium is used for the culture of vascular cells, in particular endothelial cells, pericytes, pericyte-like-cells and smooth muscle cells.

69. Culture medium according to any of claims 47 to 63, characterized in that the culture medium is used for the culture of non-vascular cells, in particular from hepatocytes.

70. Culture medium according to any of claims 48 to 69, characterized in that the culture medium is used for the precoating of vascular prostheses, cardiac valves and bypasses in tissue engineering.

71. Culture medium according to any of claims 48 to 70, characterized in that the culture medium is used within the framework of tissue engineering.

72. Culture medium according to any of claims 48 to 71, characterized in that the culture medium is used as a preservation solution in tissue banking.

73. Culture medium according to any one of claims 48 to 72, characterized in that, that autologous growth factors are gained through mechanical destruction of body-own tissues.
